(19) United States
(12) Patent Application Publication
(10) Pub. No.: US 2019/0073707 A1
(43) Pub. Date: Mar. 7, 2019

(54) SYSTEM FOR PROCUREMENT OF RESOURCES WITHIN A CONTROLLED ENVIRONMENT

(71) Applicant: Elior, Inc., Charlotte, NC (US)

(72) Inventors: Brian Caspari, Frisco, TX (US); Brian Lother, Golden Valley, MN (US); Danny Nguyen, Mounds View, MN (US)

(73) Assignee: Elior, Inc., Charlotte, NC (US)

(21) Appl. No.: 16/122,221

(22) Filed: Sep. 5, 2018

Related U.S. Application Data
(60) Provisional application No. 62/554,746, filed on Sep. 6, 2017.

(51) Int. Cl. G06Q 30/06; G06Q 10/08; G06Q 20/10

(52) U.S. Cl. CPC G06Q 30/0607; G06Q 20/108; G06Q 10/0832

(57) ABSTRACT

Systems, computer program products, and methods are described herein for a system for procurement of resources within a controlled environment. The present invention is configured to receive information associated with one or more inmates; receive, from an external source, an order to procure resources for at least one of the one or more inmates; determine that the at least one of the one or more inmates is eligible to receive the resources; initiate a transfer of the resources from the external source to the at least one of the one or more inmates; and transmit control signals configured to cause the at least one processor to initiate a presentation of a user interface on a computing device associated with the external source to indicate a completion of the transfer of resources.

### PRIORITY CLAIM

This application claims priority to U.S. Provisional Application Ser. No. 62/554,746 entitled “SYSTEM FOR PROCUREMENT OF RESOURCES WITHIN A CONTROLLED ENVIRONMENT”, filed Sep. 6, 2017, which is incorporated herein by reference in its entirety.

### FIELD OF THE INVENTION

The present invention embraces a system for procuring resources within a controlled environment.

### BACKGROUND OF THE INVENTION

Many family members of inmates wish to send their inmates packages with food, clothing, magazine, and books. However, there are a number of correspondence restrictions on the type of items that inmates are allowed to receive from friends and family. There is a need for a system for procuring resources that have been pre-approved by the institution in a more efficient and reliable manner while safeguarding against the introduction of restricted items.

### SUMMARY OF THE INVENTION

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for procurement of resources within a controlled environment is presented. The system comprises at least one non-transitory storage device; at least one processor; and at least one module stored in said storage device and comprising instruction code that is executable by the at least one processor and configured to cause said at least one processor to: receive information associated with one or more inmates; receive, from an external source, an order to procure resources for at least one of the one or more inmates; determine that the at least one of the one or more inmates is eligible to receive the resources based on at least the information associated with the at least one of the one or more inmates; initiate a transfer of the resources from the external source to the at least one of the one or more inmates based on at least determining that the at least one of the one or more inmates is eligible to receive the resources; and transmit control signals configured to cause the at least one processor to initiate a presentation of a user interface on a computing device associated with the external source to indicate a completion of the transfer of resources.

In some embodiments, the module is further configured to: receive, in real-time, information associated with the one or more inmates, wherein the information further comprises one or more security levels associated with each of the one or more inmates.

In some embodiments, the information associated with the one or more inmates is received periodically.

In some embodiments, the module is further configured to: initiate a presentation of a first user interface for display on the computing device associated with the external source, wherein the first user interface comprises an indication of the resources available to the external source for procurement; receive, via the first user interface, a selection of the resources; and initiate the transfer of the resources selected by the user based on at least receiving the selection of the resources from the external source.

In some embodiments, the module is further configured to receive, via the first user interface, one or more options associated with the transfer of the resources selected by the external source, wherein the one or more options comprises a location of the at least one inmate to whom the external source wishes to transfer the resources to, and a delivery time associated with the procurement of the resources, wherein the location further comprises a state and a name of an entity in which the at least one inmate is incarcerated.

In some embodiments, the module is further configured to determine a resource allowance associated with the one or more inmates, wherein the resource allowance comprises at least one or more limits associated with the procurement of the resources, wherein the one or more limits comprises a total amount of funds available for the external source to spend for the one or more inmates periodically, a total amount of funds available for the external source to spend for each of the one or more inmates based on at least one security level associated with the each of the one or more inmates, and a total number of resources per transfer.

In some embodiments, the module is further configured to: receive from the external source, the order to procure resources for the at least one of the one or more inmates; determine that the order to procure resources has exceeded the one or more limits; and initiate a presentation of an alert interface for display on the computing device associated with the external source, wherein the alert interface comprises an indication that that the one or more limits have been met.

In some embodiments, the module is further configured to receive from the computing device associated with the external source and via the alert interface, to place the resources exceeding the resource allowance on hold, and to be executed when the resource allowance associated with the at least one of the one or more inmates has been reset.

In some embodiments, the module is further configured to initiate a presentation of a second user interface for display on the computing device associated with the external source indicating that the resource allowance associated with the at least one of the one or more inmates has been reset.

In some embodiments, the module is further configured to: receive the order to procure resources for the at least one of the one or more inmates from the external source; place the order in one or more queues for processing; determine that the at least one of the one or more inmates is not eligible to receive the resources; place the order on hold, wherein placing further comprises transferring the order from the one or more queues to a temporary volatile memory location for a predetermined period of time; determine whether the at least one of the one or more inmates becomes eligible to receive the resources within the predetermined period of time; and (i) execute the order if the at least one of the one or more inmates becomes eligible to receive the resources within the predetermined period of time, wherein executing further comprises transferring the order from the temporary volatile memory location back to the one or more queues, or (ii) cancel the order if the at least one of the one or more inmates does not become eligible to receive the resources within the predetermined period of time, wherein cancelling further comprises deleting the order from the temporary volatile memory location.

In another aspect, a computerized method for procurement of resources within a controlled environment is presented. The method comprising: receiving information associated with one or more inmates; receiving, from an external source, an order to procure resources for at least one of the one or more inmates; determining that the at least one of the one or more inmates is eligible to receive the resources based on at least the information associated with the at least one of the one or more inmates; initiating a transfer of the resources from the external source to the at least one of the one or more inmates based on at least determining that the at least one of the one or more inmates is eligible to receive the resources; and transmitting control signals configured to cause the at least one processor to initiate a presentation of a user interface on a computing device associated with the external source to indicate a completion of the transfer of resources.

In yet another aspect, a computer program product for procurement of resources within a controlled environment is presented. The computer program product comprising a non-transitory computer-readable medium comprising code causing a first apparatus to: receive information associated with one or more inmates; receive, from an external source, an order to procure resources for at least one of the one or more inmates; determine that the at least one of the one or more inmates is eligible to receive the resources based on at least the information associated with the at least one of the one or more inmates; initiate a transfer of the resources from the external source to the at least one of the one or more inmates based on at least determining that the at least one of the one or more inmates is eligible to receive the resources; and transmit control signals configured to cause the at least one processor to initiate a presentation of a user interface on a computing device associated with the external source to indicate a completion of the transfer of resources.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for procuring resources within a controlled environment, in accordance with an embodiment of the invention;

FIG. 2 illustrates a process flow for procuring resources within a controlled environment, in accordance with an embodiment of the invention; and

FIGS. 3-4 illustrate exemplary graphical user interfaces for resource procurement, according to an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a prison, correctional facility, detention center, jail, penitentiary, or the like in which inmates are forcibly confined and denied a variety of freedoms under the authority of the state. These entities employ information technology resources and particularly technology infrastructure configured for processing information related to the inmates, people who work for the organization, its products or services, internees, or any other aspect of the operations of the organization. As such, the entity may be any institution, group, association, establishment, company, union, authority or the like.

As described herein, an “inmate” may be an internee, prisoner, convict, or detainee associated with an entity.

As described herein, a “user” may be any individual, entity or system who has a relationship with an inmate associated with the entity (e.g., family members, friends, or the like). In some embodiments, the user may not have a relationship with an inmate associated with the entity.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user or output data to a user. These input and output devices may include a display, mouse, keyboard, button, touchpad, touch screen, microphone, speaker, LED, light, joystick, switch, buzzer, bell, and/or other user input/output device for communicating with one or more users.

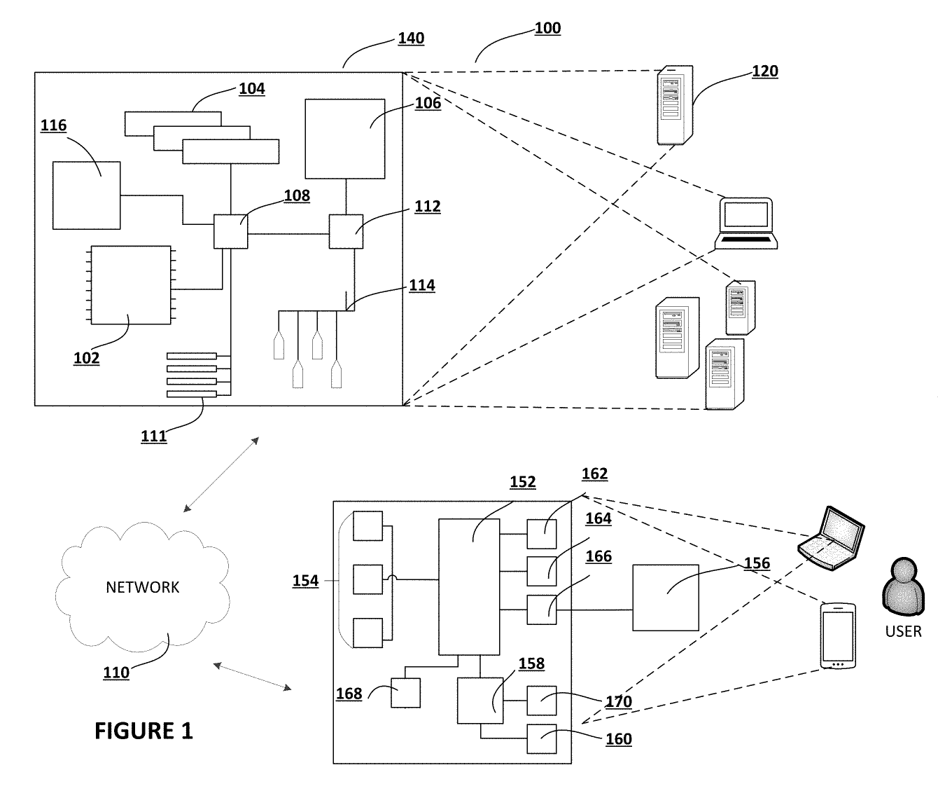

FIG. 1 presents an exemplary block diagram of the system environment for a system for procuring resources within a controlled environment. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute one or more applications stored thereon. The one or more applications may be configured to communicate with the system 130, perform a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 1408 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation—and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

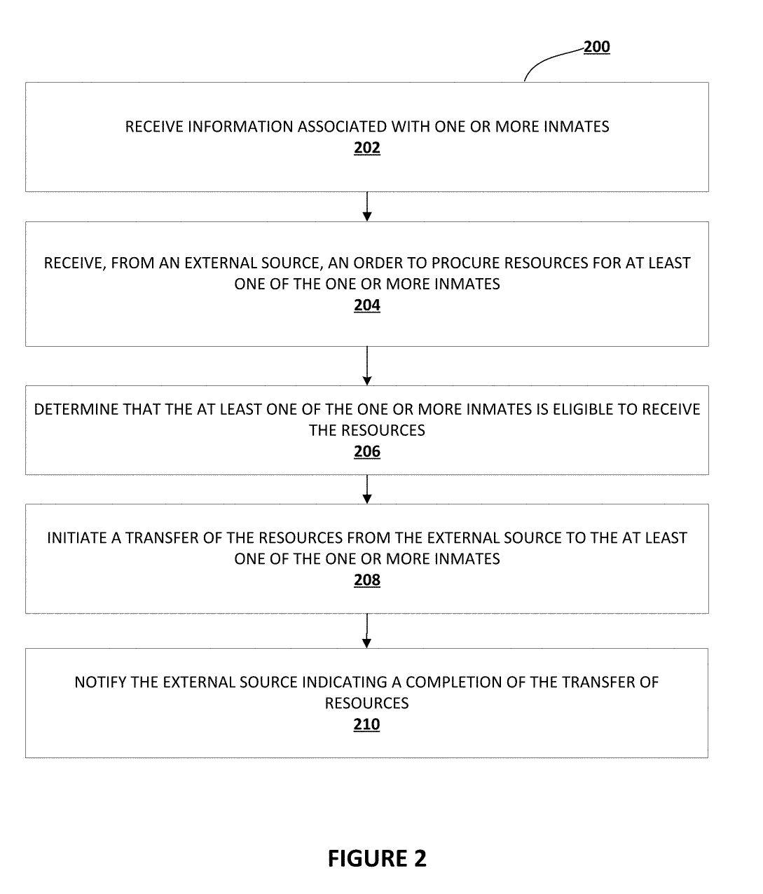

FIG. 2 illustrates a process flow for procuring resources within a controlled environment 200, in accordance with an embodiment of the invention. As shown in block 202, the process flow includes receiving information associated with one or more inmates. In this regard, the system may be configured to establish a communication link with one or more servers associated with the technological infrastructure of the entity. In doing so, the system may be configured to receive information associated with the inmates. In some embodiments, the information associated with the inmates may include names of inmates who are eligible to receive resources from an external source. Inmates are typically categorized into one or more groups based on one or more factors associated with their incarceration. In one aspect, the factors include custodial levels (e.g., close, medium, minimum I, minimum II, minimum II, or the like). Typically, the custodial levels are based on public safety risks presented by the inmate. In another aspect, the factors include control statuses (e.g., maximum, death row, intensive, safekeeper, disciplinary, administrative, protective, or the like), where control statuses further restrict inmate freedoms and privileges. Assignment and removal of inmates from these statuses is generally at the discretion of higher level classification authorities (e.g., wardens, guards, board, or the like). In yet another aspect, the factors include prison security levels (e.g., close, medium, and maximum). Typically, prison security levels indicate the extent to which an offender who is assigned to that facility is separated from the civilian community. In yet another aspect, the factors include inmate behavior, work ethic within the entity, or the like. In some embodiments, an inmate group may indicate the eligibility of an inmate to receive resources from an external source.

In some embodiments, the information associated with the inmates may be received periodically. Typically, the classification of an inmate into one or more groups is periodically reviewed by monitoring and tracking inmate behavior and allows for an inmate to work his way to a lower security level resulting in increased eligibility for programs, or, conversely, to higher security levels as a result of behavioral problems. In addition, factors such as the offenses for which they are incarcerated may limit the security level that an inmate may achieve. In some other embodiments, the information associated with the inmates may be updated and pushed via notifications if there are any changes in the inmate's categorization. In some other embodiments, the system may be configured to receive, in real-time, the information associated with the inmates.

Next, as shown in block 204, the process flow includes receiving, from an external source, an order to procure resources for at least one of the one or more inmates. In some embodiments, the external source may be user (e.g., family or friends associated with the inmate), a third party, an organization (non-profit or otherwise), or the like. For purposes of the invention, the external source is a user. In one aspect, the system may be configured to receive the order to procure resources from the user via the user computing device associated with the user. In this regard, the system may be configured to initiate a presentation of a graphical user interface for display on the user computing device. The user may then choose, via the graphical user interface, one or more options associated with resource procurement for the inmate. Examples of resources may include rations (e.g., specific types of food, ingredients, meal plans, or the like), gift baskets comprising personal hygiene products, or any products previously authorized by the entity. In some embodiments, the user may have to specify the location of the inmate they wish to send resources to. In one aspect, the location of the inmate may include a state and a name of the entity in which the inmate is incarcerated. In some other embodiments, the user may choose to order resources to be delivered to the inmate at a later date.

In some embodiments, the user may be required to set up an account to be able to order resources. Once the account is set up, the user may be required to log into the account each time the user wishes to place an order to procure resources. In some embodiments, the user may be required to provide authentication credentials each time the user wishes to access the account. For example, a user may authenticate his or her identity using a unique alias such as a username and/or password. Further, in some situations, challenge questions, familiar pictures and/or phrases, biometrics, key fob-based alphanumeric codes and/or collocation, authentication of another application such as a similar application or an “overarching” application, and/or the like may be used as types of identity authentication.

In some embodiments, the system may be configured to establish one or more parameters limiting resource procurement. In one aspect, the parameters limiting resource procurement may be established on the user end. In some embodiments, the resources procured by the user may be limited by a total amount of funds spent by the user to procure the resources for an inmate each time, each week, each month, or the like. For example, the user may be limited to spend $100 each time an order is placed for resource procurement. In another example, the user is limited to spend $500 per week on resource procurement for an inmate. In some other embodiments, the resources procured by the user may be limited by a number of resources procured by the user at a time. For example, the user may be limited to a total of 10 items per order. In yet another embodiment, the resources procured by the user may be limited by the categorization of the inmate. For example, a user may be allowed to procure resources worth $50 for an inmate in a higher risk category but may be allowed to procure resources worth $100 for an inmate in a low risk category. In another aspect, the parameter limiting resource procurement may be established on the inmate end. In some embodiments, the resources procured by the user may be limited by a total amount of funds spent on resource procurement for the inmate. For example, each inmate may be allowed to receive resources worth $500 each week. If the inmate has already received had an aggregate amount exceeding the allowable limit for the week, then the user is notified that the limit for the inmate has been met. In some embodiments, once the inmate is eligible to receive additional resources, the user is notified of the change. In one aspect, by enabling the user to procure resources for the inmate at a future date, the system may be configured to provide the user with the option to execute the order when the inmate's resource allowance is reset.

Next, as shown in block 206, the process flow includes determining that the at least one of the one or more inmates is eligible to receive the resources. In some embodiments, the system may be configured to receive the location of the entity and the name of the inmate the user wishes to send the resource. This way, if the inmate is eligible to receive the resource, the system may be configured to initiate a notification to the user indicating whether the inmate is eligible to receive the resource. In some embodiments, the system may be configured to initiate a presentation of a graphical user interface for display on the user computing device indicating whether the inmate is eligible to receive the resources.

In one aspect, if the inmate is not eligible to receive the resource, the system may be configured to present the user with the order on hold until the inmate becomes eligible to receive the resource again. In this regard, the system may be configured to place the order on hold for a predetermined period of time. If the inmate becomes eligible to receive the resource during the predetermined period of time, the system may be configured to initiate the transfer of resources. However, if the inmate does not become eligible to receive the resource during the predetermined period of time, the system may be configured to cancel the order and refund the user. In another aspect, if the inmate is not eligible to receive the resource, the system may be configured to cancel the order and refund the user immediately. In some embodiments, the system may be configured to notify the user of the inmate's change in eligibility status when the inmate becomes eligible to receive resources. In this regard, the system may be configured to initiate a presentation of a graphical user interface for display on the user device indicating that the inmate has become eligible to receive the resource. In response, the system may be configured to enable the user to confirm the order if the user is still within the predetermined period of time, or resend the order if the predetermined period of time has lapsed. Similarly, the system may be configured to provide the user with the option to resend the order if the order had been canceled previously. In one aspect, by enabling the user to procure resources for the inmate at a future date, the system may be configured to provide the user with the option to execute the order when the inmate becomes eligible to receive resources.

In some embodiments, each order received from the user is processed by placing the order in one or more queues. During the time the order is placed in the queue, the system may be configured to determine whether the inmate is eligible to receive the resources associated with the order. If the inmate is eligible, then the order is removed from the queue and processed. If the inmate is currently ineligible, the order is then removed from the queue and placed in a temporary memory location (cache/volatile memory) for the predetermined period of time for faster access and efficient data retrieval. During this time, other orders placed in the queue continue to be processed. If the inmate becomes eligible to receive the resource within the predetermined period of time, the system may be configured to transfer the order from the temporary memory location back into the queue for continued processing. On the other hand, if the inmate does not become eligible within the predetermined period of time, the order is deleted from the temporary memory location.

In some embodiments, the inmate may be eligible to receive the resources when the order is initially placed, but becomes ineligible to receive the resources between the time the order is placed, and the time the order is processed and resources shipped to the entity from the vendor. In such cases, if the order is processed, and the resources have been shipped, the resources are held in abeyance for a predetermined period of time. If the inmate becomes eligible to receive the resources during this time, the resources are then provided to the inmate. If the inmate does not become eligible to receive the resources within the predetermined period of time, the resources are not provided to the inmate, and instead are returned to the vendor. If the order has not yet been processed, and the resources have not been shipped, the system may be configured to remove the order from the queue and store the order in a temporary memory location for a predetermined period of time. If the inmate becomes eligible to receive the resource within the predetermined period of time, the system may be configured to transfer the order from the temporary memory location back into the queue for continued processing. On the other hand, if the inmate does not become eligible within the predetermined period of time, the order is deleted from the temporary memory location.

Next, as shown in block 208, the process flow includes initiating a transfer of the resources from the external source to the at least one of the one or more inmates. In some embodiments, the resource transfer is initiated based on at least determining that the inmate is eligible to receive the resources. In response, the resources are then prepared to be shipped to the inmate from the vendor. In one aspect, the resources are shipped from the vendor to the entity, where the resources are inspected and processed using existing mailing and shipping infrastructure within the entity.

In some embodiments, when the order is placed by the user, the system may be configured to receive payment information and authorization to charge the user a predetermined amount to process the order and ship the resources to the inmate. In some embodiments, the payment information is processed prior to processing the order. In some other embodiments, the payment information is processed concurrently with the order. In such cases, if the payment information is incorrect, or falsified, the system may be configured to void the transaction and notify the user of the action. In one aspect, the system may be configured to provide the user with the option to reorder the resources. During this time, the system may be configured to transfer the order from the queue and place it in a temporary memory location for a predetermined period of time. If the user rectifies the error, or reorders the resources, the system may be configured to transfer the order from the temporary memory location to be placed back in the queue for continued processing. If the user does not rectify the error, or reorder the resources within the predetermined period of time, the system may be configured to delete the order from the temporary memory location. However, in some other embodiments, the payment information is processed after the order is processed and the resources shipped to the inmate. To avoid this scenario, prior to receiving the resources, the inmate is required to acknowledge that any discrepancy in the funds used to order the resources will be automatically settled using the inmate's personal commissary account. In the alternate, the inmate is provided the option to refuse the resources and/or opt out of the program altogether.

Next, as shown in block 210, the process flow includes notifying the external source indicating a completion of the transfer of resources. In this regard, the system may be configured to initiate a presentation of a graphical user interface for display on the user computing device indicating that the resources have been delivered by the vendor to the entity and/or the resources have been received by the inmate. In some embodiments, the user may be notified via a text message, an email, a pop-up notification, an automated voice message, or the like. In some embodiments, the system may be configured to provide the user with continuous updates during the processing of the order from the time the order is placed by the user until the resources associated with the order are received by the inmate.

In some embodiments, the system may be configured to enable the user to generate a report, in real-time, based on the various resources procured by the user. In one aspect, the system may be configured to generate a report based on historical purchases, categories of resources most purchased by the user, an average amount of funds spent by the user each time, number of orders, and/or the like. Although reports may be requested and received by the user, it should be appreciated that the reports may be generated automatically either periodically, or after the occurrence of a particular event. In some embodiments, the reports are generated on an ad-hoc basis by queries submitted by the user. In one aspect, these queries allow the user to generate customized detailed reports on aspects related to resource procurement orders executed by the user.

In some embodiments, the system may be configured to determine whether an inmate who had previously received resources from the user during incarceration has recently been re-incarcerated. In such cases, the system may be configured to notify the user of the inmate's re-incarceration.

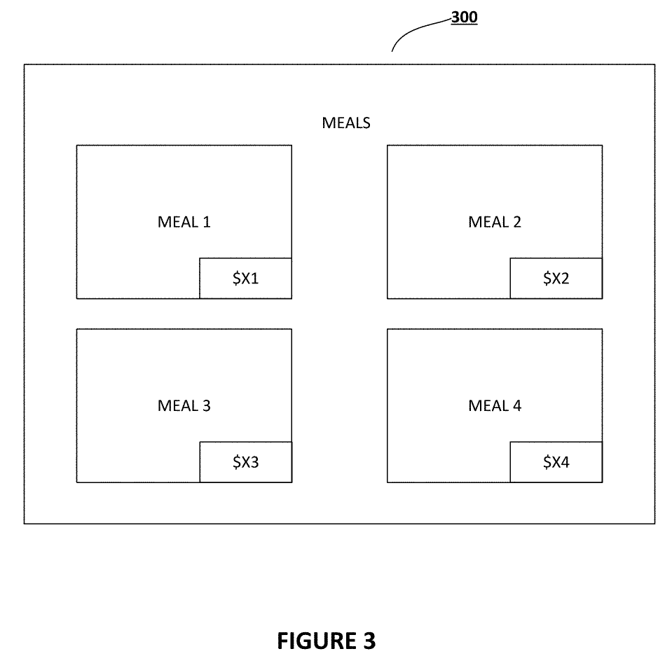

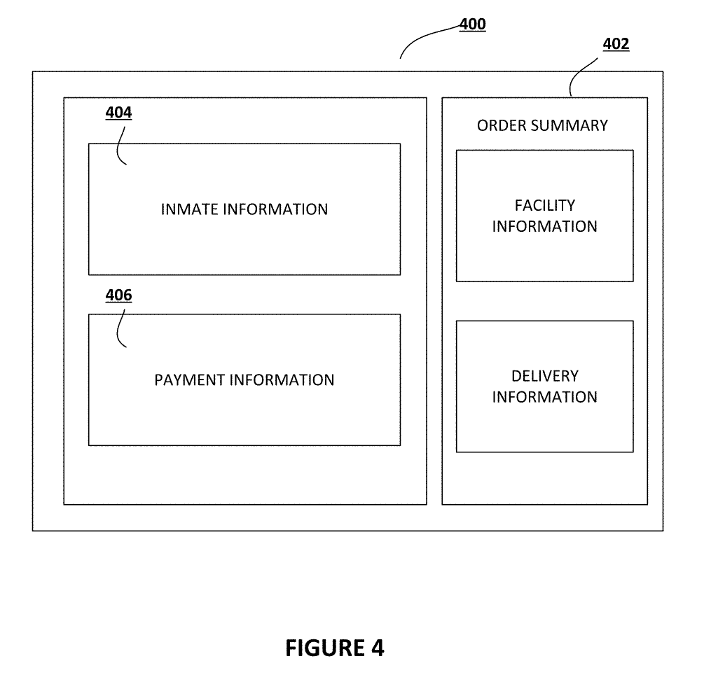

FIGS. 3-4 illustrate exemplary graphical user interfaces for resource procurement, according to an embodiment of the invention 300-400. FIG. 3 shows various resources (Meal 1, Meal 2, Meal 3, and Meal 4) available for the user to purchase for the inmate and a corresponding price for each resource. FIG. 4 shows a summary of the order placed by the user to procure resources for the inmates 402. In some embodiments, the order summary includes facility information and delivery information. As described herein, the system may be configured to provide the user with an option to select a facility (e.g., entity) in which the inmate the user wishes to send resources to, is incarcerated, and a state in which the facility is located. In some other embodiments, the delivery information indicates shipping time and policies for delivery of the resources. FIG. 4 also shows information associated with the inmate 404 the user wishes to send resources to, including but not limited to, inmate ID, last name, gender, date of birth, and/or the like. In some embodiments, in response to the user's input, the system may be configured to initiate the presentation of a graphical user interface to verify the information. In addition, FIG. 4 shows payment information 406 indicating a method of payment used by the user to procure resources for the inmate.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for procurement of resources within a controlled environment, the system comprising:
at least one non-transitory storage device;
at least one processor; and
at least one module stored in said storage device and comprising instruction code that is executable by the at least one processor and configured to cause said at least one processor to:
receive information associated with one or more inmates;
receive, from an external source, an order to procure resources for at least one of the one or more inmates;
determine that the at least one of the one or more inmates is eligible to receive the resources based on at least the information associated with the at least one of the one or more inmates;
initiate a transfer of the resources from the external source to the at least one of the one or more inmates based on at least determining that the at least one of the one or more inmates is eligible to receive the resources; and
transmit control signals configured to cause the at least one processor to initiate a presentation of a user interface on a computing device associated with the external source to indicate a completion of the transfer of resources.

2. The system of claim 1, wherein the at least one module is further configured to:
receive, in real-time, information associated with the one or more inmates, wherein the information further comprises one or more security levels associated with each of the one or more inmates.

3. The system of claim 2, wherein the at least one information associated with the one or more inmates is received periodically.

4. The system of claim 1, wherein the at least one module is further configured to:
initiate a presentation of a first user interface for display on the computing device associated with the external source, wherein the first user interface comprises an indication of the resources available to the external source for procurement;
receive, via the first user interface, a selection of the resources; and
initiate the transfer of the resources selected by the user based on at least receiving the selection of the resources from the external source.

5. The system of claim 4, wherein the at least one module is further configured to:
receive, via the first user interface, one or more options associated with the transfer of the resources selected by the external source, wherein the one or more options comprises a location of the at least one inmate to whom the external source wishes to transfer the resources to, and a delivery time associated with the procurement of the resources, wherein the location further comprises a state and a name of an entity in which the at least one inmate is incarcerated.

6. The system of claim of 2, wherein the at least one module is further configured to:
determine a resource allowance associated with the one or more inmates, wherein the resource allowance comprises at least one or more limits associated with the procurement of the resources, wherein the one or more limits comprises a total amount of funds available for the external source to spend for the one or more inmates periodically, a total amount of funds available for the external source to spend for each of the one or more inmates based on at least one security level associated with the each of the one or more inmates, and a total number of resources per transfer.

7. The system of claim 6, wherein the at least one module is further configured to:
receive from the external source, the order to procure resources for the at least one of the one or more inmates;
determine that the order to procure resources has exceeded the one or more limits; and
initiate a presentation of an alert interface for display on the computing device associated with the external source, wherein the alert interface comprises an indication that that the one or more limits have been met.

8. The system of claim 7, wherein the at least one module is further configured to receive from the computing device associated with the external source and via the alert interface, to place the resources exceeding the resource allowance on hold, and to be executed when the resource allowance associated with the at least one of the one or more inmates has been reset.

9. The system of claim 8, wherein the at least one module is further configured to initiate a presentation of a second user interface for display on the computing device associated with the external source indicating that the resource allowance associated with the at least one of the one or more inmates has been reset.

10. The system of claim 1, wherein the at least one module is further configured to:
receive the order to procure resources for the at least one of the one or more inmates from the external source;
place the order in one or more queues for processing;
determine that the at least one of the one or more inmates is not eligible to receive the resources;
place the order on hold, wherein placing further comprises transferring the order from the one or more queues to a temporary volatile memory location for a predetermined period of time;
determine whether the at least one of the one or more inmates becomes eligible to receive the resources within the predetermined period of time; and
(i) execute the order if the at least one of the one or more inmates becomes eligible to receive the resources within the predetermined period of time, wherein executing further comprises transferring the order from the temporary volatile memory location back to the one or more queues, or (ii) cancel the order if the at least one of the one or more inmates does not become eligible to receive the resources within the predetermined period of time, wherein cancelling further comprises deleting the order from the temporary volatile memory location.

11. A computerized method for procurement of resources within a controlled environment, the method comprising:
receiving information associated with one or more inmates;
receiving, from an external source, an order to procure resources for at least one of the one or more inmates;
determining that the at least one of the one or more inmates is eligible to receive the resources based on at least the information associated with the at least one of the one or more inmates;
initiating a transfer of the resources from the external source to the at least one of the one or more inmates based on at least determining that the at least one of the one or more inmates is eligible to receive the resources; and
transmitting control signals configured to cause the at least one processor to initiate a presentation of a user interface on a computing device associated with the external source to indicate a completion of the transfer of resources.

12. The method of claim 11, wherein the method further comprises receive, in real-time, information associated with the one or more inmates, wherein the information further comprises one or more security levels associated with each of the one or more inmates.

13. The method of claim 12, wherein the information associated with the one or more inmates is received periodically.

14. The method of claim 11, wherein the method further comprises:
initiating a presentation of a first user interface for display on the computing device associated with the external source, wherein the first user interface comprises an indication of the resources available to the external source for procurement;
receiving, via the first user interface, a selection of the resources; and
initiating the transfer of the resources selected by the user based on at least receiving the selection of the resources from the external source.

15. The method of claim 14, wherein the method further comprises receiving, via the first user interface, one or more options associated with the transfer of the resources selected by the external source, wherein the one or more options comprises a location of the at least one inmate to whom the external source wishes to transfer the resources to, and a delivery time associated with the procurement of the resources, wherein the location further comprises a state and a name of an entity in which the at least one inmate is incarcerated.

16. The method of claim 12, wherein the method further comprises determining a resource allowance associated with the one or more inmates, wherein the resource allowance comprises at least one or more limits associated with the procurement of the resources, wherein the one or more limits comprises a total amount of funds available for the external source to spend for the one or more inmates periodically, a total amount of funds available for the external source to spend for each of the one or more inmates based on at least one security level associated with the each of the one or more inmates, and a total number of resources per transfer.

17. The method of claim 16, wherein the method further comprises:
receiving from the external source, the order to procure resources for the at least one of the one or more inmates;
determining that the order to procure resources has exceeded the one or more limits; and
initiating a presentation of an alert interface for display on the computing device associated with the external source, wherein the alert interface comprises an indication that that the one or more limits have been met.

18. The method of claim 17, wherein the method further comprises receiving from the computing device associated with the external source and via the alert interface, to place the resources exceeding the resource allowance on hold, and to be executed when the resource allowance associated with the at least one of the one or more inmates has been reset.

19. The method of claim 18, wherein the method further comprises initiating a presentation of a second user interface for display on the computing device associated with the external source indicating that the resource allowance associated with the at least one of the one or more inmates has been reset.

20. A computer program product for procurement of resources within a controlled environment, the computer program product comprising a non-transitory computer-readable medium comprising code causing a first apparatus to:
receive information associated with one or more inmates;
receive, from an external source, an order to procure resources for at least one of the one or more inmates;
determine that the at least one of the one or more inmates is eligible to receive the resources based on at least the information associated with the at least one of the one or more inmates;
initiate a transfer of the resources from the external source to the at least one of the one or more inmates based on at least determining that the at least one of the one or more inmates is eligible to receive the resources; and
transmit control signals configured to cause the at least one processor to initiate a presentation of a user interface on a computing device associated with the external source to indicate a completion of the transfer of resources.
